(19) United States
(12) Patent Application Publication
(10) Pub. No.: US 2015/0051937 A1
(43) Pub. Date: Feb. 19, 2015

(54) SYSTEM AND METHOD FOR OFFSET MANAGEMENT

(71) Applicant: OFFSET MARKET EXCHANGE, INC., Toronto (CA)

(72) Inventors: Nicole Josephine Verkindt, Toronto (CA); Timothy Quinn, Toronto (CA)

(73) Assignee: OFFSET MARKET EXCHANGE, INC., Toronto (CA)

(21) Appl. No.: 14/386,429

(22) PCT Filed: Mar. 15, 2013
(86) PCT No.: PCT/CA2013/000246

§ 371 Date: Sep. 19, 2014

Related U.S. Application Data
(60) Provisional application No. 61/614,622, filed on Mar. 23, 2012.

(51) Int. Cl. G06Q 10/06; G06Q 30/08

(52) U.S. Cl. CPC G06Q 10/06313; G06Q 30/08
USPC 705/7.23

(57) ABSTRACT

A system and method for managing offset project data is provided. The system includes a device which maintains the project data. Project data includes data regarding offset requirements. Transaction data can be associated with the project which can help satisfy at least a portion of the project offset requirements. Transaction data also includes causality and incrementality data for proving a transaction. Proving a transaction can be based on communications accumulated and stored at the device. To help with the communications data gathering, messaging accounts can be provided at the device that are associated with the transactions. When communicating, parties to the transaction can CC or copy the provided account as a way of automatically storing the communications.

### CROSS-REFERENCE TO RELATED APPLICATION(S)

This application is related to and claims priority to U.S. application entitled offset market exchange, having Ser. No. 61/614,622, filed 23 Mar. 2012 and incorporated by reference herein.

### BACKGROUND OF THE INVENTION

1. Field of the Invention

The present invention is directed to process system management in general and offset project system management in particular.

2. Description of the Related Art

Many regions and countries, when procuring goods and services require an investment be made in the in their region or country by the suppliers of the goods and services, typically referred to as an offset requirement. For example, a supplier of trucks to a country may be required to manufacture at least a portion of the trucks in that country, or supply other investments valued at a percentage of the value of the trucks to be supplied. Determining and proving which investments and what portions qualify to satisfy offset requirements requires complex systems for managing voluminous data.

### SUMMARY OF THE INVENTION

It is an aspect to provide a computing device for managing project offsets. The device can comprise a datastore and a processor operably coupled to the datastore. The processor can be configured for:

receiving project offset requirements;

maintaining, at the datastore, transaction data based on the project offset requirements, the transaction data including data for proving the transaction; and

determining project offset requirement satisfaction based on said transaction data.

It is another aspect to provide a method performed at a computing device for managing project offsets The method can comprise:

receiving project offset requirements;

maintaining transaction data based on the project offset requirements, the transaction data including data for proving the transaction; and

determining project offset requirement satisfaction based on said transaction data.

The data for proving a transaction can include incrementality and causality data. The incrementality and causality data can based on communications data maintained at the datastore and associated with the transaction. The communications data can include communications data originating at the computing device as well as communications data received at a designated communications account maintained at the computing device and associated with the transaction data. The transaction data can include supply element data having an offset satisfaction level satisfying at least portion of the offset requirements.

The method can further comprise:

receiving content information for the supply element data; and

determining the offset satisfaction level based on the content information received.

The method can further comprise:

receiving updates to the transaction data;

determining changes to the project offset requirement satisfaction based on the updated transaction data; and

providing an indication of the changes in project offset requirement satisfaction.

The method can further comprise:

receiving updates to the project offset requirements;

determining changes to the project offset requirement satisfaction based on the updated project offset requirements; and

providing an indication of the changes in project offset requirement satisfaction.

The project offset requirements can include format requirements for proving a transaction and the method can further comprise generating a report based on the format requirements, the report including incrementality and causality data.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows a block diagram of an aspect of a system for offset project management;

FIG. 2 shows a block diagram of offset project data in accordance with an aspect;

FIG. 3 shows a flow chart showing a method of offset project management in accordance with an aspect; and

FIG. 4 shows a flow chart showing a method of offset project management in accordance with an aspect.

### DETAILED DESCRIPTION OF THE PREFERRED EMBODIMENTS

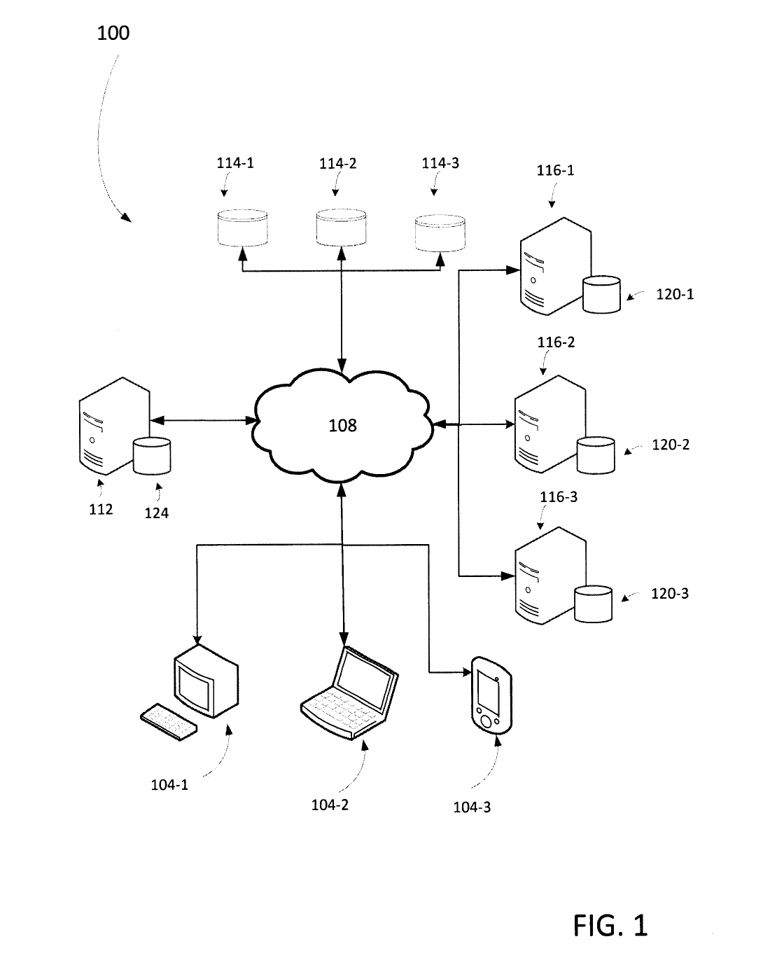

FIG. 1 shows a diagram of a system 100 for offset management. At least one client terminal (client terminals 104-1, 104-2 and 104-3) is connected, via network 108, to offset management server 112. Collectively, client terminals 104-1, 104-2 and 104-3 are referred to as client terminals 104, and generically as client terminal 104. This nomenclature is used elsewhere herein. In the present embodiment, offset management server 112 maintains a project data-store 124. Additionally, offset management server 112 can also access at least one third party server 116 (third party servers 116-1, 116-2 and 116-3) through network 108. Collectively, third party servers 116-1, 116-2 and 116-3 are referred to as third party servers 116, and generically as third party server 116. This nomenclature is used elsewhere herein. In the present embodiment third party servers 116 include third party data-stores 120. Offset management server 112, third party servers 116 and client terminals 104 can also access at least one cloud based storage 114 (cloud based storage 114-1, 114-2 and 114-3) through network 108. Collectively, cloud based storage 114-1, 114-2 and 114-3 are referred to as cloud based storage 114, and generically as cloud based storage 114. This nomenclature is used elsewhere herein.

In general terms, client terminals 104 can be based on any suitable computing environment, and the type is not particularly limited so long as each client terminal 104 is capable of receiving data from offset management server 112, displaying data and transmitting data to offset management server 112. In a present embodiment, client terminals 104 are configured to at least allow an account to access and interact with the services hosted by offset management server 112. In an embodiment, an account can access and interact with the offset management server 112 through a web browser executing at a client terminal 104. In other embodiments, other applications can be hosted and executed by terminal 104 that can be used to allow an account to access and interact with offset management server 112.

Client terminals 104 can be based on any type of client computing environment, such as a desktop computer, a laptop computer, a netbook, a tablet, a smartphone, other mobile computing device or any other platform suitable for information processing that is known in the art. Each client terminal 104 includes at least one processor connected to a non-transitory computer readable storage medium such as a memory. Memory can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. In one embodiment, memory includes both a non-volatile memory for persistent storage computer-readable instructions and other data, and a non-volatile memory for short-term storage of such computer-readable instructions and other data during the execution of the computer-readable instructions. Other types of computer readable storage medium external to client terminal 104 are also contemplated, such as secure digital (SD) cards and variants thereof. Other examples of external computer readable storage media include compact discs (CD-ROM, CD-RW) and digital video discs (DVD).

Client terminal 104 can also include one or more input devices connected to at least one processor. Such input devices are configured to receive input and provide data representative of such input to the processor. Input devices can include, for example, a keypad and a pointing device. A pointing device can be implemented as a computer mouse, track ball, track wheel, touchscreen or any suitable combination thereof. In some examples, client terminal 104 can include additional input devices in the form of one or more additional buttons, light sensors, microphones and the like. More generally, any suitable combination of the above-mentioned input devices can be incorporated into client terminal 104.

Client terminal 104 can further include one or more output devices. The output devices of client terminal 104 can include speakers, haptic feedback devices and others. The output devices of client terminal 104 can also include a display. When the pointing device includes a touchscreen, the touchscreen can be integrated with the display. Each client terminal 104 also includes a communications interface connected to the processor. The communications interface allows client terminal 104 to communicate with other computing devices, for example via network 108. The communications interface is therefore selected for compatibility with network 108.

Network 108 can comprise any network capable of linking offset management server 112 with client terminals 104 and can include any suitable combination of wired and/or wireless networks, including but not limited to a Wide Area Network (WAN) such as the Internet, a Local Area Network (LAN), cell phone networks, Wi-Fi networks, WiMax networks and the like.

In general terms, offset management server 112 can comprise any platform capable of processing, transmitting, receiving, and storing data. In a present embodiment, offset management server 112 is a server configured for project management in general and for offset management specifically. Offset management server 112 can be based on any desired server-type computing environment including appropriate configurations of one or more central processing units (CPUs) configured to control and interact with non-transitory computer readable media in the form of computer memory or a storage device. Computer memory or storage device can include volatile memory such as Random Access Memory (RAM), and non-volatile memory such as hard disk drives or FLASH drives, or a Redundant Array of Inexpensive Disks (RAID) or cloud-based storage 114. Offset management server 112 also includes one or more network interfaces, to connect to network 108 or client terminal 104. Offset management server 112 can also be configured to include input devices such as a keyboard or pointing device or output devices such as a monitor or a display or any of or all of them, to permit local interaction. Other types of hardware configurations for offset management server 112 are contemplated. For example, offset management server 112 can also be implemented as part of a cloud-based computing solution, whereby the functionality of offset management server 112 is implemented as one or more virtual machines executing at a single data center or across a plurality of data centers. The software aspect of the computing environment of offset management server 112 can also include remote access capabilities in lieu of, or in addition to, any local input devices or local output devices. Any desired or suitable operating system can be used in the computing environment of offset management server 112. The computing environment can be accordingly configured with appropriate operating systems and applications to implement the functionality discussed herein. Those of skill in the art will now recognize that offset management server 112 need not necessarily be implemented as a stand-alone device and can be integrated as part of a multi-purpose server or implemented entirely in software, for example a virtual machine. In a present embodiment, offset management server 112 is connected to a storage device, such as a hard-disk drive, solid state drive, or any other type and arrangement of non-volatile storage device.

In the present embodiment, offset management server 112 maintains a project data-store 124. Project data-store 124 can be maintained on a storage device integral to or attached to offset management server 112, or can be maintained at a remote storage facility such as a network connected storage device, at a cloud storage 114 or a combination of these storage options. Broadly speaking, project data-store 124 is any data-store containing project and related data for management of projects with offset requirements. Accordingly, project data-store 124 typically includes project data related to offset projects and their management.

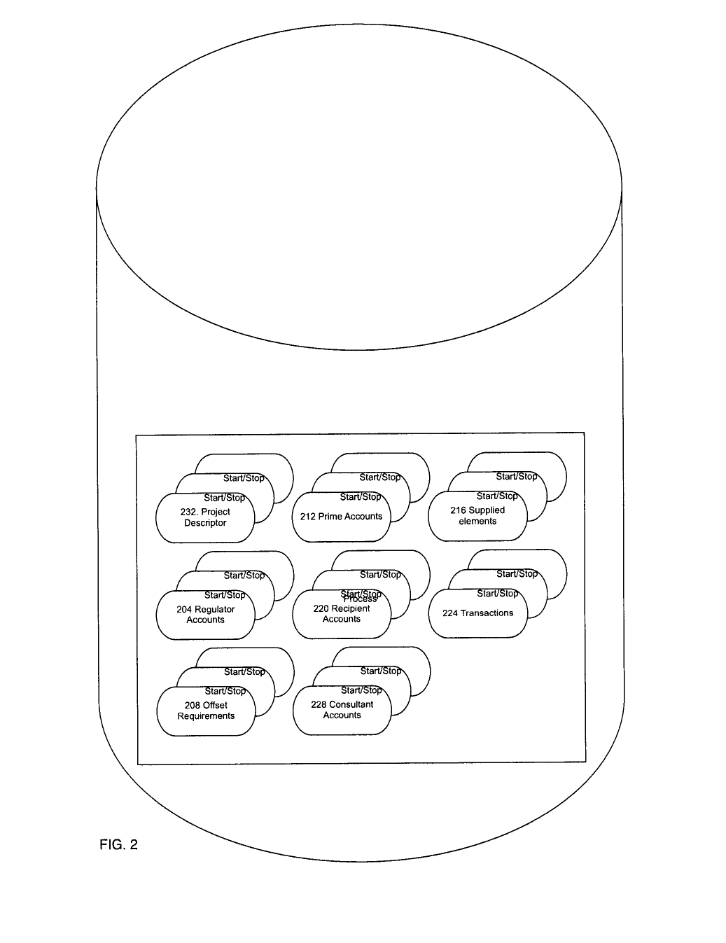

Referring now to FIG. 2, example offset project data is indicated at 200 in accordance with an embodiment. The example offset project data 200 is presented for illustrative purposes. Offset project data 200 typically also includes at least one offset regulator data 204 representing information regarding offset regulators. Generally, offset regulators are entities that set and/or regulate offset requirements. Offset regulators can be, for example, governments or components of a government, either for a country or a region, or international regulatory bodies. Other possible entities exist that can function as offset regulators, as will now occur to a person of skill in the art.

The project data 200 further includes offset requirements data, indicated at 208 in the present example embodiment. Offset requirements data 208 represents offset requirements which are trade conditions associated with a project and the specific government policy, typically specifying locality based offset investment requirements. In variations, offset requirements 208 can also include requirements or sub requirements for business size (for example small businesses), business type such as universities, types of pre-identified technology to be sources (for example, based on an enhanced priority technology list), intellectual property transfer requirements and others that will now occur to a person of skill in the art. In some implementations, the locality requirement can further specify sub-localities such as states, provinces, regions cities or others that will now occur to a person of skill in the art. For example, an exporter might be required to invest within the country it is exporting from by, for example, purchasing domestic products for export, and/or invest in the country it is exporting to. Alternatively, in some industries such as the defense industry or the resources industry, a prime that wins a contract to supply a particular country with supplied elements such as goods, services or resources might be required to make offset investments in that particular country. The required offset investments are typically tied to the value of the project, trade or contract that is regulated with an offset requirement. An offset requirement can be sub-categorized on the basis of the type of supplied elements, entities and actions to be invested invest into. For example, offset investment requirements can specify that a portion of the required offset investment be directed to a type of entity such as a university, another portion be directed to a certain activity such as research, and different portions be directed to different types of supplied elements such as environmentally friendly goods and services and other that will now occur to a person of skill in the art. A fulfillment schedule can also be included as part of an offset requirements data 208, indicating when certain portions of the offset requirements must be satisfied.

Offset requirements data 208 can additionally include locality data that can form a basis for determining locality in relation to the offset investment requirements. For example, offset requirements may include conditions specifying the basis on which an entity, such as a prime contractor, a recipient of an investment, a government, an activity such as a contract, a transaction, a trade or an investment and supplied elements such as goods, services, investments and resources can be determined to be local or domestic. For example, the conditions might specify that an entity, activity or a supply element can be categorized as domestic if it is local to the jurisdiction of an offset regulator, and categorized as international otherwise. The categorization as domestic can also be based on local content percentages, namely what percent of the supplied goods were locally produced. Accordingly, the locally produced content needs to exceed a threshold percentage specified, for example for goods to be classified as domestic. It will now be understood by a person of skill in the art that the specific conditions on the basis of which the locality of an entity, activity or a supplied element is determined can vary, and can include additional or different conditions.

Continuing with FIG. 2, project data 200 also includes data regarding primes as indicated at prime account data 212 in accordance with the present example embodiment. Prime account data 212 contains information related to primes which are entities that contemplate bidding for or have already won a contract or a project or a trade that is regulated by offset requirements, as well as sourcing work from suppliers. Prime accounts data 212 can also include account information that enables entry, management and identification of data from project data 200 that forms an individual project to be maintained in data-store 124. Prime accounts data 212 can further include data indicating whether a prime, data about which is maintained within prime accounts data 212 can be classified as domestic or international based on the locality of that prime. Furthermore, it is the primes represented by the prime account data 212 that typically have to meet the offset investment requirements as specified in offset requirements data 208.

Referring again to FIG. 2, offset investment requirements are satisfied, at least in part, on the basis of offset investments directed to supply elements indicated at supply elements data 216 in accordance with the example embodiment. Supply elements data 216 includes data that represents trade elements such as goods, services or resources. For example, supply elements data 216 can represent goods such as trucks and bolts, services such as research, training and consulting, and resources such as oil and water. Supply elements data 216 can also represent investments, whether in kind or in currency or in grants or in the form of partnerships and joint ventures, into an entity that is typically a public entity. Other supply elements will now occur to a person of skill in the art. Supply elements data 216 can include criteria related to the level or portion of offset requirements that can be satisfied by a supply element. For example, supply elements data 216 can include the dollar amount, as well as locality of supply element content for determining the level of domestic offset investment requirements that can be satisfied by directing investments into that supply element. Other criteria for offset satisfaction will now occur to a person of skill in the art and are within scope.

Continuing with FIG. 2, supply elements are typically provided by recipients represented by data contained by recipient accounts data 220. Recipients are entities who receive offset investments on the basis of supplied elements provided. Recipient account data 220 also includes account information that enables entry and management of data within project data 200 that represent activities of a recipient to be maintained in data-store 124. A recipient account data 220, for example, can be associated with one or more of the supply elements data 216 representing supply elements provided by that recipient. The locality of a recipient can also be a component of satisfying offset requirements, and can be part of recipient account data 220.

Continuing with FIG. 2, project data 200 can also include transaction data 224 as indicated at 224 in the present example embodiment. A transaction is initiated between a prime and a recipient when the prime selects a supply element to satisfy at least a part of the offset requirements for that project by, for example, linking the supply element data 216 representing that supply element with data representing that specific project. A transaction is not completed however, until transaction requirements for that transaction, which can be contained in project data 200 as part of the transaction data 224, are satisfied. For example, for a transaction to be completed in one variation, the supply element or elements pertaining to that transaction are delivered by the recipient entity and inspected and accepted by the prime entity, and all additional transaction data indicated as required are entered into project data 200.

Recipient accounts, supply elements and transaction can be categorized in numerous ways such as indirect and direct based on the supplied elements associated with a recipient account or a transaction, where the supply element forms the content of the transaction. Recipient account data 220, supply element data 216 and transaction data 224 can include additional data fields to capture these categorizations. For example, when a supply element included in supply element data 216 is used for satisfying a portion of an offset requirement for a project as indicated by offset requirements data 208, and that supply element 216 is directly related to that project, then the recipient account and the supply element can be categorized as direct for the purposes of that project, and data can be included in the associated supply element data 216, recipient accounts data 220 and transaction data 224 to indicate this categorization. For example, a prime contractor that provides military helicopters to Canada can supply work to a Canadian company that produces helicopter parts for use in producing the helicopters to be provided. The prime contractor is thus supplying work directly related to the supply of helicopters to support their offset obligation on the helicopter project. Accordingly, the supply element data 216 that represents the helicopter parts work and the transaction data 224 representing the transaction that contains the supply element for the helicopter parts would be classified as direct.

On the other hand, if a recipient account, the transaction and the associated supply element are not related to a project, then they can be categorized as indirect and data representing the supply element and the recipient account in project data 200 can be updated accordingly. For example, a prime contractor that provides military helicopters to Canada can supply work to a Canadian company that produces aircraft parts for a commercial program. The prime contractor is thus supplying work from another project to support their offset obligation on the helicopter project. Accordingly, the supply element data 216 that represents the aircraft parts work and the transaction data 224 representing the transaction that contains the supply element for the aircraft parts would be classified as indirect. An alternative example of indirect offset would be when a company, in light of receiving the helicopter project, invests in a university in the form of issuing research grants and providing engineers to support research at the university.

The determination of whether a supply element or a recipient account is direct and indirect can be based on numerous factors such as project description, the type of goods and services required by the project, and others that will now occur to a person of skill in the art.

In a variation, offset requirements data 208 can specify different requirements based on the category of a supply element data 216 and a recipient account data 220. For example, the offset investment amount that can satisfy an offset requirement can be greater if the offset requirements are satisfied using indirect supply elements as opposed to direct supply elements. Variations in categorization and associated offset requirement changes will now occur to a person of skill in the art.

Transaction data 224 can additionally include data representing a contract between the prime and the recipient and other third parties necessary to effect the provision of the supplied element. Moreover, the transaction data 224 can also include data for proving a transaction, namely that the transaction can be used in at least partially satisfying the offset requirements for a project. This data can be included as part of a transaction sheet containing information necessary for satisfaction of at least part of the offset requirements 208 associated with a project. Accordingly, transaction data 224 can include data regarding causality and incrementally for proving a transaction. Additional data for proving a transaction can include information on timing to indicate that the transaction was carried out in accordance with a fulfillment schedule, for example. Further data for proving a transaction can include data regarding eligibility of the parties entered into the transaction. As it will now occur to a person of skill in the art, additional data can be specified and included for proving a transaction that can be determined on the basis of project requirements and specification, jurisdiction and other sources. The data can take different forms such as purchase orders, proof of payment, umbrella agreements, presentations to back up causality, communications and other data that can be used in showing compliance with offset requirements.

Causality data is any data that indicates that the transaction was initiated as a result of the project, and was not a pre-existing transaction. Incrementality data is data that indicates the amounts, in terms of quantity or value or other amounts, of supply elements that are being provided as a result of this causal transaction. For example, a prime might have existing transactions in place to procure 1000 bottles of German water for a previous project. Subsequently, the prime increases the amount of the water procured to 3000 because of a project. Causality data would thus be any data indicating that the cause of the increase of 2000 bottles was the project. This would include legal documents, communications including messages such as emails, recorded voice mails, and others that will now occur to a person of skill in the art. The incrementality data would be any data that indicates the amount of supply elements being supplied in light of the causal transaction to be 2000 bottles, and could also include communications, legal documents and others. In variations, incrementally can be banked such that the production increase takes place in anticipation of a future project. In other variations not all of the money invested in a transaction can be used toward satisfying the offset requirements. For example, certain portions of a transacted work, such as taxes, foreign supplied parts and others might be unallowable for use towards satisfying offset requirements.

In one variation the causality and incrementality data could be represented as part of the existing transaction data 224 for the water bottle procurement, with information contained within the transaction data indicating which portions of the transaction are for which projects (i.e. that 1000 bottles are for one project and 2000 bottles are for another), maintaining appropriate transaction data for each project. In an alternative, a new transaction can be created for the supply of 2000 additional bottles and only that transaction linked to the project. Accordingly, transaction data 224 can represent data as separate transactions for a given supply element, or one transaction that varies as more is procured or supplied.

Transaction data 224 can be received from any account associated with a transaction, such as a prime account and/or a recipient account and/or a third party account, allowing for collaborative provisioning and editing of the data. Server 112 can include user interface and APIs for receiving documents, messages and other data related to a transaction. Transaction data can also be obtained automatically. For example, in one variation, server 112 can provide messaging services such as email services or instant messaging services such that accounts maintained by server 112 can communicate using these services. Communications made based on these services can then be logged, time stamped or maintained as part of the accounts carrying out the communication, and as appropriate as part of the projects and transactions the communications are related to. The communications can also be associated with the appropriate projects or transactions before or after they are associated with an account. Alternatively, server 112 can be copied during communications such as email and instant messaging, and when server 112 receives copied messages, it can associate them with the appropriate account and or project based on the contents of the message such as the sender, the receiver, and the subject. The copying can be done by copying a specific address provisioned by server 112 for each account or account user or transaction or project Alternatively, the copying can be done through a generic address provisioned by server 112. In a variation, the messages received on the basis of transaction or project specific accounts can be automatically associated with the appropriate accounts, transactions and projects as appropriate. Alternatively, the messages can be allocated with the appropriate projects, transactions or account either manually or automatically on the basis of the headers or contents of the message.

Any data collected can be organized in accordance with a timeline and presented either on a display or in a report in accordance with the timeline for a given transaction, project or account. In some implementations the receipt times can be associated with at least some of the data received as part of implementing the timeline presentation.

Referring again to FIG. 2, offset project data 200 can also include data pertaining to consultants or other third parties as indicated in the example embodiment of FIG. 2 at consultant account data 228. Consultant account data 228 includes data that represent consultant entities or other third parties, as well as information that enables consultant entities to maintain appropriate portions of the project data 200 contained in data-store 124. Consultant entities are third party entities that can perform various functions such as brokerage functions that enable connecting primes with supplied elements and recipients. Consultants can also act as administrators of a project. In a variation, consultant accounts can be created through prime accounts. Prime accounts can also determine consultant account access to at least portions of project data 200. In further variations, consultant accounts can be sub-accounts of a prime account such that they are contained within the prime account, created and administered by the prime-account. In other variations, consultant accounts can be accounts separate from prime accounts. Moreover, consultant accounts can initiate communications with a prime account requesting permissions to access project data for that prime in order to provide consulting services in relation to that project.

Project data 200 can also include project descriptor data as indicated at 232 in the present embodiment shown in FIG. 2. Project descriptor data 232 can allow the organization of data within project data 200 for specific projects. Project descriptor data 232 can include descriptive information regarding a project and its objectives. Furthermore, project descriptor data 232 can also include links to other data associated with a specific project and contained within project data 200 so as to associate those data with the project. For example, project descriptor data can include links to transaction data 224 representing that those linked transactions are part of that specific project.

Data-store 124 and the project data 200 contained therein can be implemented using a variety of constructs including linked lists, arrays, object oriented containers, relational or flat databases, or recursive structures amongst others. Moreover, although in the example embodiment, the project data has been stored in a single data-store 124, in other variations, the data may be stored in more data-stores or other structures organized in a different manner. Variations in the implementation of data-store 124 and the project data will now occur to one of skill in the art. For example, although in the example embodiment project data 200 has been organized in one manner, other potential methods of organizing project data 200 exist and are within scope. For example, in one variation, project description data 202 can also include offset requirements data 208 and/or offset regulator data 204. In another variation, recipient account data 220 can include supply element data 216 for supply elements provided by it. Other variations in organizing and structuring the data for project 200 will now occur to a person of skill in the art.

Referring back to with FIG. 1, and continuing with the description of system 100, third party servers 116 are also shown. Third party servers 116 can generally perform the functions of maintaining offset project related data. A third party server 116 can however access one or more other third party servers 116, or other computing devices, in order to access other third party services such as search sites and other information aggregators and others to perform one or more of its functions.

Third party servers 116 can comprise any platform capable of processing, transmitting, receiving, and storing data. Those of skill in the art will now recognize that third party server 116 need not necessarily be implemented as a stand-alone device and can be integrated as part of a multi-purpose server or implemented entirely in software, for example a virtual machine and hosted by a cloud service provider. In a present embodiment, third party servers 116 are configured to host third party services such as on-line stores, web sites, directory services, database services or other information aggregation sites, social networking services, communications services and others. Third party services can be maintained by offset regulators, recipients, primes and consultants and can be associated with their respective accounts maintained at offset management server 112 through APIs provided by the third party services or server 112. FIG. 1 shows third party server 116 to be linked to offset management server 112 through network 108, although other variations in connectivity, such as links through a network separate or different from 108 and connections through proxies and gateways is contemplated.

In the present embodiment third, party servers 116 include third party data-stores 120. Data stores 120 can be maintained on non-volatile memory such as hard disk drives or FLASH drives, or a Redundant Array of Inexpensive Disks (RAID) or cloud-based storage 114. Data-stores 120 are typically used for, in addition to other functionality, storing or maintaining project information, offset information transactional information supplied elements and others related to offset projects. For example, in the case of third party services maintained by offset regulators, a data-store 120 can include offset requirements for offset regulated projects that are available for bidding, in progress or completed. In the case of recipient maintained third party services, the data-store 120 can include data regarding the recipient t and supply elements available for provision by the recipient. In the case of third party services operated by primes, data-store 120 can include project information maintained by primes. In the case of consultant operated third party services, data included can pertain to projects available for bidding and their related offset requirements, prime and recipient information, and others that will now become apparent to a person of skill in the art.

In a variation, offset management server 112 can access third party servers 116 through APIs provided by those servers to gather project data 200. For example, once an individual project is created, a prime can specify a third party server from which data pertaining to that specific project such as project description data 202, offset regulator data 204 and offset requirements data 208 can be obtained. In one embodiment the third party server 116 providing these data can be operated by a regulator. In another variation the server can be operated by third parties, such as consultants. In other variations, other data pertaining to the project can be obtained from other third party servers 116 operated by primes and recipients. Other variations will now occur to a person of skill in the art.

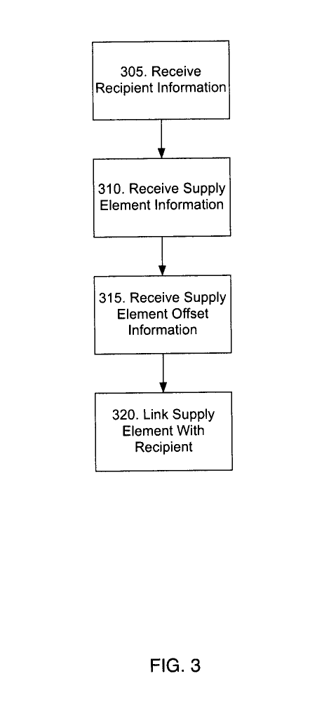

Referring now to FIG. 3, a method of supply element management is indicated generally at 300. In order to assist in the explanation of the method, it'll be assumed that method 300 is operated using system 100 as shown in FIG. 1. Additionally, the following discussion of method 300 leads to further understanding of system 100. However, it is to be understood that system 100, and method 300 can be varied, and need not work exactly as discussed herein in conjunction with each other, and that such variations are within scope.

Beginning first at 305, recipient information is received. In a present embodiment, in order to facilitate reception and maintenance of recipient information, a new recipient account is created as represented by recipient account data 220. Typically, the account will be created by a recipient. In variations the account can be created by administrators of offset management server 112 or others that will occur to a person of skill in the art and the maintenance of the account transferred to recipients. In further variations, the recipient accounts can be pre-populated with data by the creating account. Information such as recipient name, and other representative information is gathered and stored as part of recipient account data 220 that represents information for that account. The information can be gathered through the use of a user interface provided by server 112, for example. In this present example embodiment, it'll be assumed that the recipient name is ACME.

Continuing with method 300, at 310 information regarding supply elements provided by a recipient is gathered. The information can be gathered through a user interface and the gathered information is stored as part of supply element data 216. The gathered information can include the type of the element such as goods or services, the size of the supply available in units of volume, currency and units others that will now occur to a person of skill in the art, alone or in combination. The gathered information can further include locality, capacity and others that will now occur to a person of skill in the art. The information can be received through the recipient account created at 305 and maintained at offset management server 112 based on recipient account data 320. Alternatively, the information can be received through other means such as through an administrator of server 112, through a consulting account, a prime account or other methods that will now become apparent to a person of skill in the art. Continuing with the example embodiment, it'll be assumed that the supply element the information is gathered for is truck wheels, and the amount available is for 100,000 units at $100 each. It'll be further assumed that the supply element is named WHEELS.

Referring to FIG. 3, at 315 offset satisfaction information for the supply element is received and stored as part of supply element data 216. In one variation, the information can be entered manually such as $100,000 of French goods through a user interface. In an alternative variation, offset satisfaction information can be determined by offset management server 112 on the basis of a series of additional offset satisfaction basis data. In a variation, offset satisfaction basis data can be obtained from a recipient by prompting the recipient as a functionality of the recipient account. In a variation, this functionality can be part of other accounts. Alternatively, the offset basis data can be obtained through third party services through third party servers 116. Other variations for obtaining offset satisfaction information will now occur to a person of skill in the art.

Example offset satisfaction basis data includes information regarding costs, fees, taxes, locality of parts, raw materials, insurance and other information related to the provision of the supply element that will now occur to a person of skill in the art. The determination of the offset satisfaction information based on the offset satisfaction basis data can be accomplished using various methods. For example, net selling price method can be used to determine the information where the selling price can be substantiated. Alternatively, cost aggregate method can be used. Other variations will now occur to a person of skill in the art. In variations, as part of this determination specific information re the calculation of exact local content that is allowable as an offset credit is determined.

Continuing with the example, it'll be assumed that offset satisfaction information for the wheels is $10,000,000 of Canadian goods. In further variations, the offset satisfaction information can be determined, in part, on the basis of components of the supplied element, which can be additional supplied elements contained within the project data 200 themselves. Continuing with the example embodiment, WHEELS can comprise of tires and rims which have been themselves already been entered into the system as supply elements, and data for which is contained in data-store 124. Accordingly, the determination of the offset satisfaction information for the wheels can be based, in part, on the tires and the rims. Other variations of determining offset satisfaction on the basis of component supply elements will now occur to a person of skill in the art. For example, offset satisfaction determination can be delayed to a time after the supply element information has been gathered and stored. Alternatively, the offset satisfaction information can be updated on demand or periodically as offset satisfaction basis information is updated or as additional offset satisfaction basis data is gathered. For example, local content value of supplied elements can vary as the parts acquired to provide the supply element change. In some implementations, not all costs associated with a supply element can be used towards offset satisfaction. For example, consulting fees and taxes may be unallowable. Moreover, these may change in time, as the portion of consulting fees for a supply element changes for example.

Continuing with FIG. 3, the supply element information is associated with the recipient at 320. This can be accomplished in various ways. For example, supply element data 116 for that particular supply element can be linked to recipient account data 220 for that recipient. Continuing with the example, it'll be assumed that the recipient account data 220 for ACME is linked to supply element data 216 for the supply element WHEELS.

In variations, 310 through 320 can be repeated as many times as desired to receive information regarding as many different supply elements as available. In further variations, supply element data 216 can be received by server 212 at a time before a recipient account is created. The supply element data 216 can also be received through other accounts or third party servers. The recipient can then be invited to create a recipient account as appropriate.

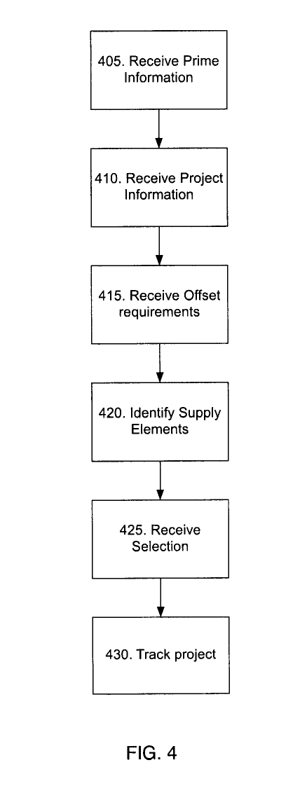

Referring now to FIG. 4, a method of offset project management is indicated generally at 400. In order to assist in the explanation of the method, it'll be assumed that method 400 is operated using system 100 as shown in FIG. 1. Additionally, the following discussion of method 400 leads to further understanding of system 100. However, it is to be understood that system 100, and method 400 can be varied, and need not work exactly as discussed herein in conjunction with each other, and that such variations are within scope.

Beginning first at 405, prime information is received. In the present embodiment, in order to facilitate reception and maintenance of prime information, a new prime account is created as represented by prime account data 212. Typically, the account will be created by a prime but, in variations the account can be created by administrators of offset management server 112 or others that will occur to a person of skill in the art. Information such as prime name and other representative information is typically gathered through a user interface and stored as part of prime accounts data 212. In the present example embodiment, it'll be assumed that the prime name is PRIME.

Continuing with method 400, project descriptor is received at 410. In the present example embodiment, project descriptor information is maintained as project descriptor data 232 in order to facilitate reception and maintenance of project information and can be acquired through a user interface, for example. Accordingly, in some embodiments, creation of a new project descriptor represents the creation of a new project. In some embodiments, descriptive information regarding a project and its objectives are also received and stored as part of project descriptor data 232. In the present example embodiment, project information stored will be assumed to be for a project for supplying 100 trucks, named “TRUCK”, to the Government of Canada.

A project descriptor data 232 can also include links to other data associated with a specific project and contained within project data 200 so as to associate those data with the project. At 415, offset requirements data for the project are acquired and associated with the project descriptor data 232a. The offset requirement information acquired include, but are not limited to, percentage of the project value to be offset, locality information, further sub-categorization of offset requirements and others that will now occur to a person of skill in the art. In the present example embodiment, it'll be assumed that the offset requirement received is for 50% of the value of the trucks supplied on the basis of project TRUCK. Moreover, it'll be assumed that the offset requirements are further sub-categorized such that at least half of the offset must be direct. Furthermore, the locality is assumed to be Canada such that the offset investments must be made in Canada. All this data is stored as part of project descriptor data 232.

At this point, the project descriptor data 232 can also be associated with a particular offset regulator data representing the offset regulator responsible for regulating the project. If the data does not exist within project data 200, new regulators account data 208 can be added for that regulator entity. The data can be added by a prime account or another account or administrator of server 112 on the bases of a request placed by one of the accounts. Continuing with the present example, the offset regulator is assumed to be the Government of Canada, and it is further assumed that offset regulator account data 208 already exists in data-store 124, and is associated with the project by linking the project descriptor data 232 for project TRUCK with the regulator account data 208 for the Government of Canada.

Continuing with FIG. 4, supply elements suitable for offset satisfaction are identified. The identification can be done automatically on the basis of the data associated with the project. For example, existing supply elements data 216 data can be searched on the basis of the locality requirement for the project. In a variation, supply elements data 216 can also be searched on the basis of other criteria such as other offset satisfaction requirements, whether the investment would be direct or indirect, the type of the supply elements, and others that will now occur to a person of skill in the art. Whether a supply element is to be considered direct or not can also be determined manually or automatically. For example, project descriptor data 232 can include criteria that can indicate whether supply element data 216 can be classified as direct or an indirect supply element for a given project. The criteria can include descriptive elements such as description of goods and services that are required for the project, as well as their volume, dollar amount and other criteria that will now occur to a person of skill in the art. The determination can be based on the specified criteria. As an example, if a project includes French bolts as a criteria indicating that bolts are needed to be purchased in France to complete a project and if supply element data 216 includes data indicating French bolts as a supply element, then the matched criteria can indicate that the supply element data indicating French bolts can be categorized as a direct offset for that project. In the present example, it'll be assumed that the project descriptor data 232 for the TRUCK project specifies Canadian truck wheels as criteria. Accordingly, it'll be further assumed that the WHEELS supply element data for which is included in supply element data 216 will be identified as a supply element that can potentially satisfy direct offset requirement for the TRUCK project.

In variations, the identification of supply elements can be further filtered through other identification criteria. For example, certain recipients, as represented by recipient account data 220, can be prioritized by tagging, bookmarking or other means. Accordingly, the supply elements provided by those recipients can be prioritized in the results, or in variations, presented prior to a search being carried out. In further variations, the identification of supply elements suitable for offset satisfaction can be made by other accounts such as a consulting account or a recipient accounts. For example, recipient accounts can search for projects with unsatisfied offset requirements that include criteria that match supply elements associated with that recipient account. Once such projects are identified, recipient account can send supply element information to the prime account. In other variations, the project may be laid open for bids such that recipients can make bids for projects whose offset requirements can be satisfied by supply elements associated with the recipient account indicating they are supplied by the recipient account. This can occur even if the offset element data is not entered into the project data 200. Alternatively, at the time an offset element is entered into the system and periodically thereafter, the system can automatically identify projects suitable for the supply element, suitability determined based on the offset requirements of the project and other suitable criteria that will now occur to a person of skill in the art.

In some variations, supply element, data transaction data, prime data and/or recipient data location or mapping information such as geocodes or geolocation can be included. Accordingly, an account searching for a supplier/recipient, a prime whose projects to bid on or for supply elements can identify these at least in part on the basis of regional location. Accordingly, the identification of the desired data can be accomplished through visual means such as maps presented on a graphical display. For example, a prime account can request to identify recipient accounts that are able to provide supply elements in certain regions. Accordingly, server 112 can cause a map of the region or regions to be presented including the requested information such as recipients or supplied elements. The requested data can be indicated by including various markings on a graphical representation of a region or an area such as a map to identify the recipient or supplied element for example. Moreover, the requested element can be selected through the graphical representation by selecting the indicator. Additional markings can be used to indicate whether the recipient is a preferred, highly rated or an accredited recipient. Other methods of indicating components of project data 204 will now occur to a person of skill in the art.

In some implementations, a prime account may choose to identify recipient accounts in place of or in addition to identifying supply elements. In variations, recipient accounts that can satisfy the project criteria can be automatically identified on that basis. In other variations, the prime account can be presented with a list of recipients prioritized by ratings. The ratings for a recipient account can be provided by primes or other accounts that have previously dealt with the recipient. For example, at the end of a transaction or a project, prime or other accounts can be asked through a user interface to rate the recipient. Alternatively, the ratings can be based on an accreditation of the recipient. For example, operators of server 112 can require a certain number of quality criteria to be satisfied prior to allowing a recipient into system 100. The accreditation can be ongoing, and also categorized or ranked, such that different recipients can get different levels of accreditation based on the level of satisfaction of the criteria beyond the threshold required to enter the system. Part of the criteria can include verification of content value satisfaction for supply elements provided by that recipient, quality of manufacturing services provided and others that will now occur to a person of skill in the art. Prime accounts or others can also exchange collaborative notes on a given recipient and its ratings.

Continuing with method 400, at 425 a selection is received. Typically this involves selecting one of the supply elements identified as suitable for satisfying, at least in part, the project's offset requirements through a user interface. The selection is typically performed by the prime account but in variations the selection can be performed by other accounts such as consultant accounts, other third party accounts or administrators of server 112. Once a selection is received, the supplied element is linked to the project and a transaction is initiated for the supply element. For example, project descriptor data 232 can be linked to or other otherwise associated with the newly created transaction data 224 indicating that the transaction is part of the specific project represented by project descriptor data 232. Additional transaction data 224 can be added at this point as well, including any contracts, letter of agreements, communications, and other data relevant to the transaction that will occur to a person of skill in the art.

Continuing with Method 400, a project is tracked. The project tracking occurs to ensure compliance with project requirements. Accordingly, server 112 tracks project data 200 to ensure that all data indicating successful completion of a project is collected by providing workflows, notifications, and data addition and editing services. Determination of project completion can be based in part by determining whether a project's offset requirements, as indicated by the project's requirements data 208 have been fully satisfied through completed transactions linked to the project's data and whether sufficient transaction data exists to prove all the transactions. Additional events can also indicate completion of a project. For example, a project might be created in anticipation for making a bid for a government contract so as to gather preliminary data necessary for making the bid. If the bid is not successful, the project can be considered completed at that point.

The project tracking can occur through the provision of a user interface. For example, a project dashboard user interface that allows tracking of a project can be maintained by server 112 can be provided. Projects can be tracked in accordance with various categories such as by region or business size. While tracking a project, the status of the project can be presented, for example, as indicated at a status portion of the dashboard. Status information can include offset requirements, offset requirements not yet satisfied, number of transactions, status of transactions, summary of the project and its requirements, progress of fulfillment and other information that will now occur to a person of skill in the art. Alerts can also be provided as, for example, fulfillment schedule milestones are approached, and in particular when the status requirements are not fully met, when transaction changes result in offset requirement changes, and other events and criteria that will now occur to a person of skill in the art.

While being tracked, a project can also be edited by modifying its data, deleting it, or by adding new transactions. Furthermore, new transactions can be added through selectors in the dashboard. The selection of selector to add a transaction can result in the performance of 420 and 425 of method 400, for example, to add a transaction.

Project dashboard can also include information regarding the transactions, including a summary. The summary can be organized by a time period, region and other criteria that will now occur to a person of skill in the art. The summary can also include a list of transactions as organized, by a time period, region and other criteria that will now occur to a person of skill in the art. Transactions can also be updated to indicate the progress of the transaction such as how much of the supply element has actually provided, to add changes to transaction details, changes to offset requirement and other information that will now occur to a person of skill in the art.

Projects can be also tracked through project dashboards that in addition or alternatively present information regarding all of the projects tracked by an account such as a prime, recipient or consultant account. This view can include summary information regarding a combination of all projects, or projects filtered by region, time, value, status, and other filter criteria that will now occur to a person of skill in the art.

In a variation, management of data for a given project can be collaborative, with access from various locations and sub-entities of the prime entities. For example, sub-prime accounts can be provided for different functional components of the prime entity such as finance, marketing and project management. Accordingly, collaborative management of a project is enabled by providing access to a given project's data through various sub-prime accounts. Sub-prime accounts can be separate accounts or they can be accounts contained as sub-accounts of the prime account. In a further variation, management of data for a given project can be collaborative, with access from various locations and account types. Accordingly, recipients, primes and consultants, for example, can collaborate in managing and maintaining a project.

Server 112 can also facilitate the generation of reports for a project or a transaction. Reports can be generated at any time during the lifetime of a project or transaction and can include data stored within project data 200 in a manner that can be used in satisfying the format requirements of offset regulators for data submission. For example, a report can include transaction sheets, communications that support causality an incrementality and other data that is required by an offset regulator to prove transactions and to indicate the satisfaction of project offset requirements. The report can be formatted based on specifications of an offset regulator. The format specifications can be part of the project data 200, for example part of the regulator account data 204 or project descriptor data 232 or offset requirements data 204. In variations, the projects can be managed and reports generated for internal prime account use, such as compliance with the finance department internally.

Although the example embodiment involved a single transaction and a single project, project data 200 can include multiple prime accounts, multiple recipient accounts, multiple transactions and projects, multiple offset regulators and third party accounts. Moreover, in some variations, recipients can also be primes. For example, a recipient that supplies wheels may have procured the tires and rims for the wheels as a prime through transactions with other recipients.

The many features and advantages are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to.

What is claimed is:

1. A computing device for managing project offsets comprising:
a datastore;
a processor operably coupled to the datastore, the processor configured for:
receiving project offset requirements;
maintaining, at the datastore, transaction data based on the project offset requirements, the transaction data including data for proving the transaction; and
determining project offset requirement satisfaction based on said transaction data.

2. The device of claim 1 wherein the data for proving a transaction includes incrementality and causality data.

3. The method of claim 2 wherein the incrementality and causality data are based on communications data maintained at the datastore and associated with the transaction.

4. The device of claim 3 wherein the communications data comprises one of:
communications data originating at the computing device; and
communications data received at a designated communications account maintained at the computing device and associated with the transaction data.

5. A method performed at a computing device for managing project offsets comprising:
receiving project offset requirements;
maintaining transaction data based on the project offset requirements, the transaction data including data for proving the transaction; and
determining project offset requirement satisfaction based on said transaction data.

6. The method of claim 5 wherein the data for proving a transaction includes incrementality and causality data.

7. The method of claim 6 wherein the incrementality and causality data are based on communications data maintained by the computing device and associated with the transaction.

8. The method of claim 7 wherein the communications data comprises one of:
communications data originating at the computing device; and
communications data received at a designated communications account maintained at the computing device and associated with the transaction data.

9. The method of claim 5 wherein the transaction data includes a supply element data having an offset satisfaction level satisfying at least portion of the offset requirements.

10. The method of claim 9 further comprising:
receiving content information for the supply element data; and
determining the offset satisfaction level based on the content information received.

11. The method of claim 5 further comprising:
receiving updates to the transaction data;
determining changes to the project offset requirement satisfaction based on the updated transaction data; and
providing an indication of the changes in project offset requirement satisfaction.

12. The method of claim 5 further comprising:
receiving updates to the project offset requirements;
determining changes to the project offset requirement satisfaction based on the updated project offset requirements; and
providing an indication of the changes in project offset requirement satisfaction.

13. The method of claim 5 wherein the project offset requirements include format requirements for proving a transaction, the method further comprising:
generating a report based on the format requirements, the report including incrementality and causality data.

14. The method of claim 5 wherein maintaining transaction data further comprises:
identifying a supply element satisfying one or more offset requirements;
receiving a selection of the supply element; and
initiating a selection based on the selection.

15. The method of claim 14 wherein the identifying comprises receiving bids from recipient accounts and receiving a selection comprises receiving a winning bid.

16. The method of claim 5 wherein the project offset requirements include a fulfillment schedule, the method further comprising:
generating alerts based on the fulfillment schedule.

17. The method of claim 6 wherein the transaction data includes transaction volume data and the incrementality data comprises data identifying the portion of the transaction volume data that is based on the project offset requirements.

18. The method of claim 6 wherein the causality data comprises data identifying the transaction as initiated based on project offset requirements.

19. The method of claim 5 wherein maintaining transaction data further comprises:
identifying a recipient account based on one of accreditation of the recipient or the rating of the recipient;
receiving a selection of the supply element; and
creating the transaction data based on the selection.

20. The method of claim 5 further comprising:
indicating the maintained transaction data on a graphical representation of a region.
